(19) United States
(12) Patent Application Publication
(10) Pub. No.: US 2016/0347518 A1
(43) Pub. Date: Dec. 1, 2016

(54) CONTAINER HAVING MULTIPLE COMPARTMENTS

(71) Applicant: The Folger Coffee Company, Orrville, OH (US)

(72) Inventors: Paige Elizabeth Janer, Fairlawn, OH (US); Brian Eugene Eib, Fort Wayne, IN (US)

(21) Appl. No.: 14/724,271

(22) Filed: May 28, 2015

(51) Int. Cl. B65D 51/28; A23F 5/10; B65D 85/00; B65D 25/04; B65D 25/54

(52) U.S. Cl. CPC B65D 51/28; B65D 25/04; B65D 25/54; B65D 85/70; A23F 5/105

(57) ABSTRACT

A container comprising a first compartment, an overcap, and a second compartment is provided. The overcap is configured to operatively engage with the first compartment. About 12˜40 vertical grooves are disposed on the second compartment. This second compartment is also configured to operatively engage with the overcap and, in doing so, a displayable space is therein defined. The displayable space is configured to enclose a promotional package such as, for example, a sample package of roast and ground coffee. The container exhibits advantages of a larger displayable space volume without sacrificing the strength of the container, and without the need to use additional resin material.

### FIELD OF THE INVENTION

Described herein is a container having multiple compartments useful for packing food products, and more particularly a container comprising a first compartment for holding roast and ground coffee, an overcap, and a second compartment for delivering a sample package of roast and ground coffee.

### BACKGROUND OF THE INVENTION

Plastic coffee containers such as those described in U.S. Pat. No. 7,169,418 are being used more and more to deliver coffee to consumers. With the increasing amounts of coffee sold to consumers in plastic containers, there is now a desire to deliver to consumers samples of new or different flavors or blends of roast and ground coffee in addition to their standard coffee purchases. Thus, such different flavors or blends (including new flavors and blends newly being introduced into the marketplace) are often sold or given away in smaller packages as promotional items. Smaller packages, among other things, allow consumers to try a different flavor or blend of coffee that they have not tried before and also allow coffee manufacturers to introduce these new flavors or blends incrementally. To facilitate the practice of promoting different or new flavors or blends of coffee, manufacturers would like to introduce these different or new flavors or blends on a smaller scale and without requiring the consumer to have to pay a premium for an entirely separate packaged product, whether or not this product is in a small package or a large package. In addition, the loyalty of certain coffee drinkers to a specific or particular flavor or blend is well known, and thus it is increasingly difficult for coffee manufacturers to convince such loyal coffee drinkers to test or to try a different or a new flavor or blend of roast and ground coffee.

Furthermore, promotional packaging designs that are currently in the marketplace present problems for the consumer as well as for the manufacturer and the shipper. Some of these designs include attaching a smaller package of product to the outside of a larger container, for example, using plastic wrap to attach a bag of product onto the side of a round canister. Such designs create problems for manufacturers in that they inhibit achievable production rates and impose additional burdens onto conventional packaging procedures. Further, these designs may also present problems during shipping if the wrapped package is not uniform in both size and shape. Finally, these designs can become a nuisance when they reach the consumer if, for example, the wrapping is difficult to remove in order to use the promoted product.

As a result, ways to achieve better packaging for promotional samples and items have been previously attempted. US Patent Application 20090114650 by Houston et al. teaches a packaging system comprising a container, a first overcap, and a second overcap. The first overcap is configured to be operatively engaged around the container. The second overcap is configured to be operatively engaged to the first overcap and defines an enclosure region. The enclosure region is configured to enclose a package, such as a sample package of roast and ground coffee. However, the enclosure region associated with this packaging system is too small to house sample packages that are larger in size.

Thus, a need still exists to provide an improved container design having multiple compartments, one which can accommodate larger sample package(s), and which is sufficiently robust in design but that does not demand higher material usage.

### BRIEF DESCRIPTION OF THE INVENTION

To address the current needs, the present invention is directed to a container for product such as roast and ground coffee. Various embodiments of the container are contemplated, including:

Embodiment #1: A container comprising:

a first compartment having a closed bottom, an open top, and a first body therebetween, wherein the closed bottom, the open top, and the first body define a first interior volume for containing a first product; and wherein the first body defines a first perimeter about the open top;

an overcap configured to be operatively engaged to the first perimeter, wherein the overcap has a second perimeter; and

a second compartment having a closed round top with a radius R, an open bottom, a second body therebetween, and an engagement skirt attached to the open bottom, wherein the engagement skirt is configured to be operatively engaged to the second perimeter of the overcap; wherein the overcap removably seals the open bottom; and wherein the closed top, the overcap, and the second body define a displayable space for displaying a second product;

wherein the weight of the second compartment is W, the volume of the displayable space is V, and V/W is in the range of 12˜35 mL/gram.

Embodiment #2: The container according to Embodiment #1, wherein V/W is in the rage of 14˜25 mL/gram.

Embodiment #3: The container according to Embodiment #1, wherein V/W is in the range of 16˜20 mL/gram.

Embodiment #4: The container according to anyone of the previous embodiments, wherein the container can withstand a top load pressure P, and wherein P/πR² is up to 10 lbs. per square inch.

Embodiment #5: The container according to Embodiment #4, wherein P/πR² is up to 9.5 lbs. per square inch.

Embodiment #6: The container according to Embodiment #4, wherein P/πR² is up to 8.9 lbs. per square inch.

Embodiment #7: The container according to anyone of the previous embodiments, wherein the second body includes 12˜40 vertical grooves.

Embodiment #8: The container according to Embodiment #7, wherein the second body includes 20˜38 vertical grooves.

Embodiment #9: The container according to Embodiment #7, wherein the second body includes 25˜35 vertical grooves.

Embodiment #10: The container according to anyone of Embodiments #7˜#9, wherein the each of the grooves has a width W, and W/R is in the range of from 2% to 7%.

Embodiment #11: The container according to Embodiments #10, wherein W/R is in the range of from 3% to 6%.

Embodiment #12: The container according to Embodiments #10, wherein W/R is in the range of from 4% to 5%.

Embodiment #13: The container according to anyone of Embodiments #10˜#12, wherein each of the grooves has a depth D, and D/W is in the range of from 10% to 24%.

Embodiment #14: The container according to anyone of Embodiments #10˜#12, wherein D/W is in the range of from 11% to 20%.

Embodiment #15: The container according to anyone of Embodiments #10˜#12, wherein D/W is in the range of from 12% to 15%.

Embodiment #16: The container according to anyone of the previous embodiments, wherein the closed round top takes the form of a dome having a perimeter, and an elevated ridge surrounding the perimeter.

Embodiment #17: The container according to Embodiment #16, wherein the height of the elevated ridge is Hc, and Hc/R is in the range of 9˜11%.

Embodiment #18: The container according to Embodiment #16, wherein the height of the elevated ridge is Hc, and Hc/R is in the range of 9.5˜10.5%.

Embodiment #19: The container according to Embodiment #16, wherein the height of the elevated ridge is Hc, and Hc/R is in the range of 9.7˜10.3%.

Embodiment #20: The container according to anyone of Embodiments #16˜#19, wherein the height of the dome is Hd, and Hd/R is in the range of 9˜12%.

Embodiment #21: The container according to anyone of Embodiments #16˜#19, wherein the height of the dome is Hd, and Hd/R is in the range of 9.5˜11.5%.

Embodiment #22: The container according to anyone of Embodiments #16˜#19, wherein the height of the dome is Hd, and Hd/R is in the range of 10˜11%.

Embodiment #23: The container according to anyone of the previous embodiments, wherein the height of the second body is Hb, and Hb/R is in the range of 45˜95%.

Embodiment #24: The container according to Embodiment #23, wherein Hb/R is in the range of 47˜75%.

Embodiment #25: The container according to Embodiment #23, wherein Hb/R is in the range of 50˜60%.

Embodiment #26: The container according to Embodiment #16, wherein the radius of the dome is Rd, and Rd/R is in the range of 95˜99%.

Embodiment #27: The container according to Embodiment #26, wherein Rd/R is in the range of 95.5˜98%.

Embodiment #28: The container according to Embodiment #26, wherein Rd/R is in the range of 96˜97%.

Embodiment #29: The container according to anyone of the previous embodiments, wherein the first product is a retail product such as a food product e.g. pet food.

Embodiment #30: The container according to anyone of the previous embodiments, wherein the second compartment is translucent or transparent.

Embodiment #31A: The container according to anyone of the previous embodiments, wherein the first product and the second product are the same type of food product.

Embodiment #31B: The container according to anyone of the previous embodiments, wherein the first product and the second product are different types of food product.

Embodiment #32: The container according to Embodiment #31, wherein the first food product has a different flavor than the second food product.

Embodiment #33: The container according to anyone of the previous embodiments, wherein the first product is roast and ground coffee.

Embodiment #34: The container according to anyone of the previous embodiments, wherein the second product is roast and ground coffee.

Embodiment #35: The container according to anyone of the previous embodiments, wherein the second product is a packaged product.

Embodiment #36: The container according to anyone of the previous embodiments, wherein the second compartment further comprises a third product for displaying.

Embodiment #37: The container according to Embodiment #36, wherein the third product is a food product.

Embodiment #38: The container according to Embodiment #36, wherein the third food product is a sweetener.

Embodiment #39: The container according to anyone of the previous embodiments, wherein the second product is a measuring scoop for use with roast and ground coffee.

Embodiment #40: The container according to anyone of the previous embodiments, wherein the second product is a food product.

Embodiment #41A: The container according to Embodiment #40, wherein the food product is the same type of food product as the first product.

Embodiment #41B: The container according to Embodiment #40, wherein the food product is a different type of food product than the first product.

Embodiment #42: The container according to Embodiment #41, wherein the food product and the first product are roast and ground coffee.

Numerous advantages and additional aspects of the present invention will be apparent from the description of the embodiments and drawings that follow.

### BRIEF DESCRIPTION OF THE DRAWINGS

While this specification includes a description of the container and concludes with claims directed to the invention, it is believed that both will be better understood by reference to the drawings wherein:

FIG. 1 is an exploded perspective view of a container having a first compartment defined by a closed bottom, a body, and an open top, and an overcap.

FIG. 2 is a cross-sectional view of a portion of the overcap in FIG. 1 as it appears when it is operatively engaged with the first compartment.

FIG. 3 is an expanded, cross-sectional view of the region labeled 3 in FIG. 2 when the first compartment is in an unpressurized state.

FIG. 4 is an expanded, cross-sectional view of the region labeled 3 in FIG. 2 when the first compartment is in a pressurized state.

FIG. 5 is an isometric view of an alternative overcap for the container in FIG. 1.

FIG. 6 is a bottom planar view of the alternative overcap of FIG. 5.

FIG. 7 is an expanded, cross-sectional view of the region labeled 7 in FIG. 5 as it appears when the alternate overcap is operatively engaged with the first compartment.

FIG. 8 is a side view of a second compartment for use with the container of FIG. 1.

FIG. 9 is a side view of an alternative second compartment for use with the container of FIG. 1.

FIG. 10 is a side view of the second compartment of FIG. 9 as it appears when it is operatively engaged with the container of FIG. 1.

FIG. 11 is an expanded, cross-sectional view of the region labeled 11 in FIG. 10 as it appears when the second compartment is operatively engaged with the container of FIG. 1.

FIG. 12 is top cross-sectional view of the second compartment of FIG. 9.

FIG. 13 is a side view of a second compartment for use with the container of FIG. 1.

### DETAILED DESCRIPTION OF THE INVENTION

All documents cited herein are incorporated by reference in their entirety. The citation of any document is not to be construed as an admission that it is prior art with respect to the present invention.

The invention herein will generally be described in terms of a container having multiple compartments for a food product. Further, while roast and ground coffee is disclosed as being an exemplary food product for incorporation within the container, it should be understood that any type of food product may be incorporated within this container.

In general, one embodiment includes a container comprising a first compartment for holding a food item, such as roast and ground coffee, an overcap, and a second compartment. The overcap is configured to be operatively engaged to the first perimeter of the first compartment. The second compartment is configured to be operatively engaged to the second perimeter of the overcap and defines a displayable space. The displayable space is configured to enclose a package, such as a sample package of roast and ground coffee. Other aspects of embodiments of the present invention will be described hereinafter.

One embodiment includes a first compartment, an overcap, and a second compartment. The first compartment is configured to hold roast and ground coffee. The overcap can be secured to the first compartment to keep the roast and ground coffee inside the first compartment both fresh and covered. The second compartment can then be attached to the secured overcap. For example, the second compartment can have a closed round top with a radius R, an open bottom, a second body therebetween, and an engagement skirt attached to the open bottom. The engagement skirt is configured to be operatively engaged to the second perimeter of the overcap. In such an arrangement, the overcap not only removably seals the first compartment, it also removably seals the open bottom of the second compartment. The volume defined by the closed top of second compartment, the second body of the second compartment and the overcap forms a displayable space for displaying a second product. The weight of the second compartment is W, the volume of the displayable space is V, and V/W is in the range of 12˜35 mL/gram, preferably in the range of 14˜25 mL/gram, and more preferably in the range of 16˜20 mL/gram (e.g. 17.37 mL/gram).

Thus, a displayable space is formed and can be used for housing a sample product. The sample product could be anything capable of fitting within the displayable space, for example, a package of roast and ground coffee having a flavor or a blend that is different from the flavor or blend of the roast and ground coffee inside the first compartment. Thus, if a suitable displayable space is designed to be sufficiently large enough, the container is capable of providing the consumer with the opportunity to try larger sized samples of new or specialty products or different varieties of current products. In some embodiments, the second compartment is made of a transparent or translucent thermoformed plastic material, such as a thermoplastic polymer, for example polyethylene terephthalate.

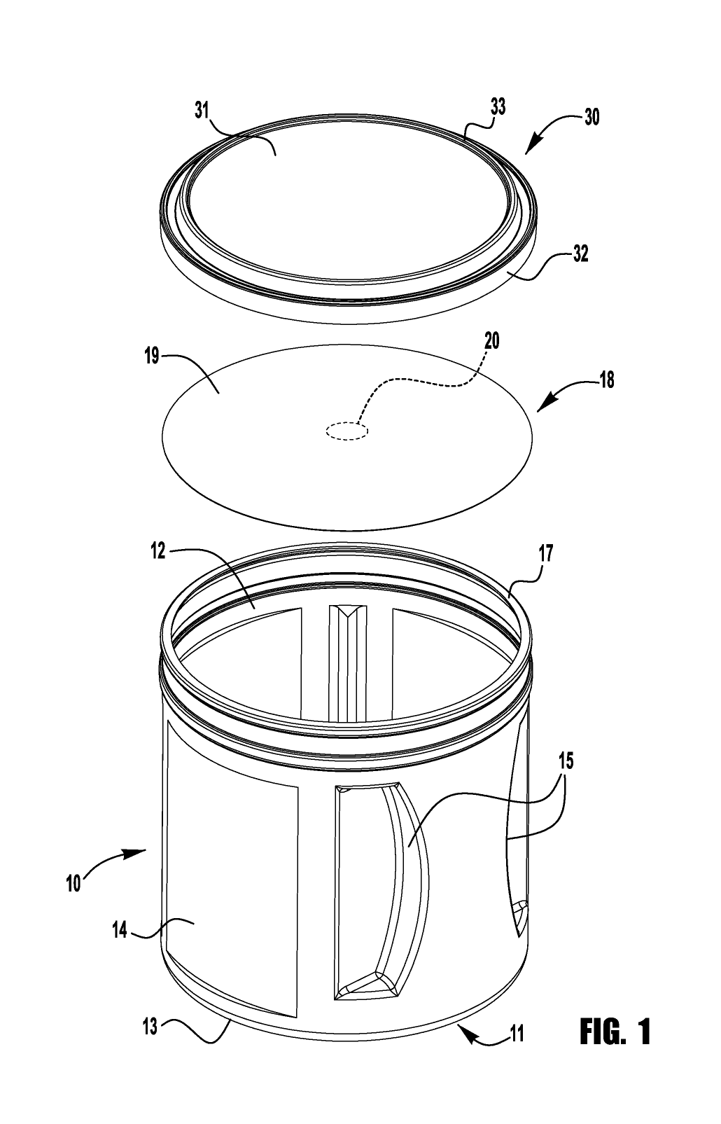

FIG. 1 details a container 10 in accordance with one exemplary embodiment. Container 10 generally comprises a first compartment 11 made from plastic, including, for example, polyolefin. Container 10 is in general accordance with those embodiments disclosed in U.S. Pat. No. 7,169,418. It is contemplated that first compartment 11 can take any number of shapes, including embodiments with or without handles, grips, or pass-through handles, and can be made of any number of suitable types of material. First compartment 11 generally comprises an open top 12, a closed bottom 13, and a first body 14. Open top 12, closed bottom 13, and first body 14 define an inner volume for containing a product, such as, for example, roast and ground coffee.

With further reference to FIG. 1, the first body 14 can be cylindrically shaped with substantially smooth sides. In another embodiment, the first body 14 has a parallelepiped shaped. Handle portions 15 are respectively formed in the first body 14 at accurate positions. Additionally, the first body 14 of first compartment 11 can define a first perimeter. The first perimeter can be in the form of a rim-like protuberance 17 disposed at the open end of first compartment 11. The first perimeter can operatively engage a peripheral lip on the overcap, such as on the skirt portion 32 of overcap 30. When the first perimeter 17 operatively engages the overcap the first compartment is closed and is sealed substantially air-tight. Protuberance 17 can provide a surface with which to removably attach a closure 18 and provide a locking surface for skirt portion 32 of overcap 30.

Further in FIG. 1, container 10 comprises a closure 18. Closure 18 can be a laminated, peelable seal 19 that is removably attached and sealed to first compartment 11 when the food product is packaged for retail sale. Peelable seal 19 can have a degassing valve, indicated by reference number 20. One-way valve 20 can be attached to the peelable seal 19 in a variety of ways including being heat welded or glued to peelable seal 19.

Again referring to FIG. 1, protuberance 17, in the form of a rim like structure, can be disposed at the open end of first compartment 11 and may have textured surfaces disposed thereon. Textured surfaces disposed on protuberance 17 can comprise raised surfaces in the form of protuberances, annular features, and/or cross-hatching to facilitate better sealing of peelable seal 19. Annular features may include a single bead or a series of beads as concentric rings protruding from the seal surface of protuberance 17. While not wishing to be bound by theory, it is believed that a textured surface on protuberance 17 may allow the application of a more uniform and/or concentrated pressure during a process for sealing the peelable seal 19. Utilizing textured surfaces can provide a means for increasing the sealing capability between protuberance 17 and peelable seal 19 and can be employed to overcome irregularities which may be introduced during molding, trimming, shipping processes, and the like during manufacture of first compartment 11. It should be understood that while FIG. 1 and other embodiments disclose a protuberance 17, containers without a protuberance are also contemplated.

Closure 18 can be sealed to first compartment 11 along a rim or protuberance 17 of first compartment 11. Methods of sealing include a heat sealing method incorporating a hot metal plate applying pressure and heat through the closure material and the container rim, causing a fused bond. The peel strength achieved is generally related to the applied pressure, temperature, and dwell time employed in the sealing process. However, other types of seals and sealing methods could be used to achieve a bond with sufficient and effective seal strength, including, but not limited to, a plurality of annular sealing beads disposed on rim or protuberance 17.

Referring again to FIG. 1, container 10 comprises an overcap 30 comprising a dome portion 31, a skirt portion 32, and rib 33. As a non-limiting example, in general, overcap 30 may be manufactured from a plastic with a low flexural modulus, for example, linear low-density polyethylene (LLDPE), low-density polyethylene (LDPE), high-density polyethylene (HDPE), polyethylene (PE), polypropylene (PP), linear low-density polyethylene (LLDPE), polycarbonate, polyethylene terephthalate (PET), polystyrene, polyvinyl chloride (PVC), copolymers thereof, and combinations thereof. These types of plastic allow the overcap 30 to have a high degree of flexibility yet to still provide sufficient rigidity to overcap to allow for the successive stacking of containers on top of each other. Using a flexible overcap 30 facilitates the mechanical application of the overcap 30 to the first compartment 11, both during the initial packaging as well as during any re-application of the overcap 30 to first compartment 11 by the consumer once it has been opened. A surprising feature of a flexible overcap 30 is the ability of the consumer to “burp” excess atmospheric gas from first compartment 11, thereby reducing the amount of oxygen present. Additionally, the thickness profile associated with the overcap 30 can be varied, in order to achieve the desired balance in flexibility and rigidity. For example, the overcap can be manufactured such that the dome portion 31 is thinner than either the skirt portion 32 or the rib 33.

Dome portion 31 is generally designed to have a curvature, and hence an associated height, in order to accommodate for an outward displacement of closure 18 from first compartment 11, a situation typically seen when products such as roast and ground coffee are packaged in the container and undergo off gassing. The amount of curvature incorporated into the dome portion 31 can be mathematically determined by making predictions about what will be the likely displacement observed with closure 18 when pressurization occurs due to off gassing. As a non-limiting example, if an internal pressure on closure 18 of about 15 millibars is achieved for a nominal 6-inch (15.25 cm) diameter overcap, then this is likely to result in a nominal height for the dome portion 31 of about 0.242 inches (0.61 cm). Further, the dome portion 31 is also generally displaceable beyond its original height as internal pressure in first compartment 11 rises, causing closure 18 to rise prior to any off gases being the released through the one-way valve 20. While dome portion 31 has been designed and described as having a curvature, other embodiments are envisioned that do not have a curvature. For example, simple flat design is also contemplated as being another possible embodiment.

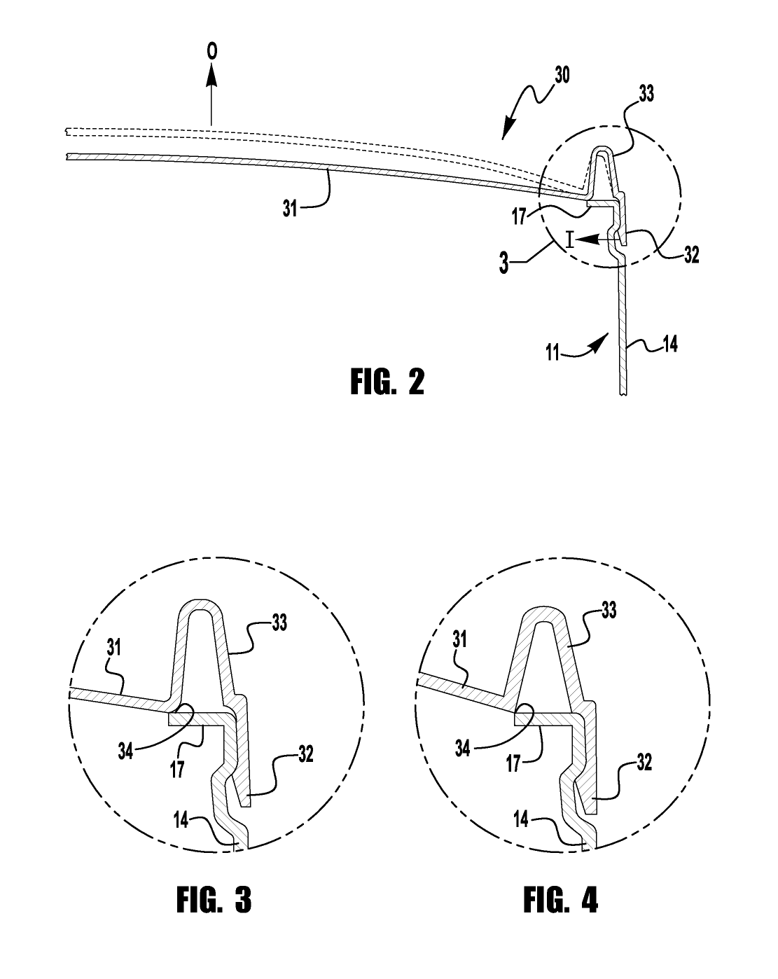

FIG. 2 details overcap 30 comprising an annular rib 33. Rib 33 protrudes outwardly from the generally curved dome portion 31 and physically connects the dome portion 31 and the skirt 32. Because the rib 33 is annular, it forms a second perimeter of overcap 30. Generally, the edge of the skirt 32 is barbed or beveled in such a manner that it engages and locks the protuberance 17 of first compartment 11. Rib 33 separates skirt 32 from dome portion 31, acting as a cantilever hinge so that outward deflections (O) of dome portion 31 are mechanically translated into inward deflections (I) of skirt 33. This cantilevered action provides for an easier application of overcap 30 to first compartment 11 and serves to effectively tighten the seal under internal pressures.

As shown in FIG. 3, an exploded view of the region 3 around rib 33, when the container 10 is closed, the outermost part of the dome portion 31 makes physical contact with protuberance 17 of first compartment 11. As a non-limiting example, first compartment 11, after opening, requires replacement of overcap 30. A consumer places overcap 30 on first compartment 11 so that an inside edge 34 of rib 33 contacts protuberance 17. A consumer then applies outward pressure on skirt 32 and, simultaneously, applies downward pressure on dome portion 31, eliminating some of the ambient air entrapped within the first compartment 11.

As shown in FIG. 3, the outermost part of the dome portion 31 is in substantial physical contact with protuberance 17 to allow the inside edge 34 of rib 33 to fully sit on protuberance 17, producing a complete seal. In a non-limiting example, protuberance 17 varies from −5° to +5° from a line perpendicular to first body 14. Inside edge 34 is designed to provide contact with protuberance 17 for this variation. As another non-limiting example, overall travel of the inside edge 34 of rib 33 has been nominally measured at three millimeters for a protuberance 17 width of four to six millimeters. It has been found that when protuberance 17 is angularly disposed, protuberance 17 forms a sufficient surface to provide for sealing adhesive attachment of closure 18 to protuberance 17.

As shown in FIG. 4, in an exemplary embodiment when the food is fresh R&G coffee, as pressure within first compartment 11 builds due to off gas from the product within, dome portion 31 of overcap 30 deflects outward. This outward deflection causes the inside edge 34 of rib 33 to migrate toward the center of first compartment 11 along protuberance 17. This inward movement results in a transfer of force through rib 33 to an inward force on skirt portion 32 to be applied to the wall of first body 14 and the outer portion of protuberance 17, resulting in a strengthened seal. Additionally, significant deflections of dome 31 due to pressurization of closure 18 causes the inside edge 34 to dislocate from protuberance 17 allowing any vented off gas to escape passed protuberance 17 to the outside of overcap 30. This design alleviates the need for a vent in overcap 30.

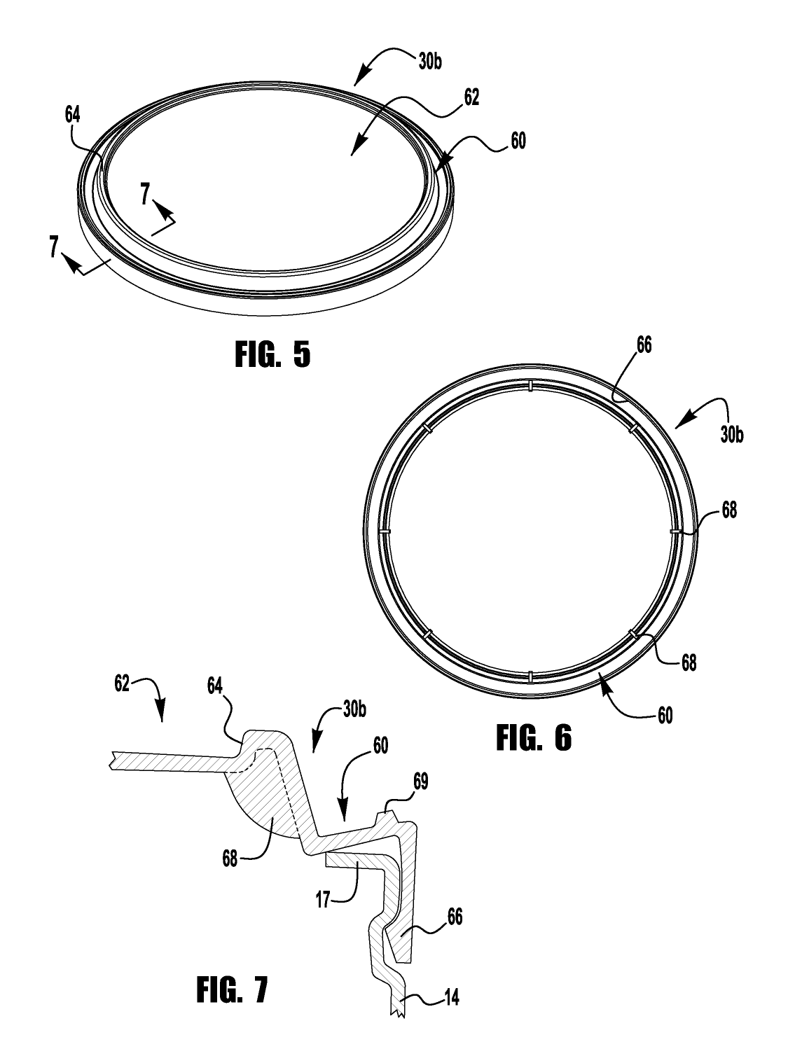

As shown in FIG. 5, an alternative embodiment of overcap 30b comprises a plurality of concentric cylindrical formations. In other words, in this alternative embodiment, the base of overcap 30b, having a diameter, d, forms a base portion 60 upon which the upper portion 62 of overcap 30b, having a diameter, d−Δd, is disposed thereon. The upper portion 62 of overcap 30b can have an annular protuberance 64 disposed thereon.

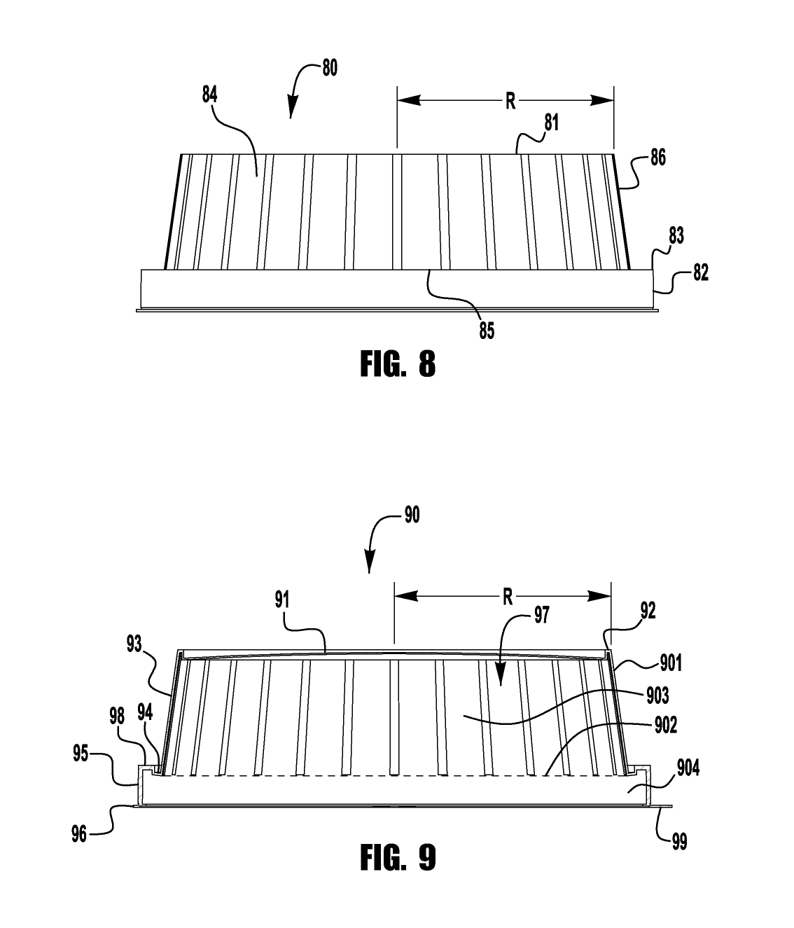

As shown in FIGS. 6 and 7, in an alternative embodiment, the inner surface of the base portion 60 of overcap 30b can have an annular sealing ring 66 disposed thereon. Annular sealing ring 66 was found to facilitate the mating of surfaces corresponding to annular sealing ring 66 and the finish portion of first compartment 11. Mating the surfaces in this manner can provide an audible signal that helps the end user to recognize that both surfaces have made contact and that a secure seal exists between protuberance 17 and the internal surface of overcap 30b. A feature of overcap 30b is the ability of the end user to expel excess atmospheric gas (i.e. air) out of the first compartment in a way that is audibly recognizable to the end user. This feature, which is effectively a “burping” of the container, removes excess atmospheric gas from first compartment 11 and thereby reduces the amount of oxygen present. Further, it is believed that an inner surface of base portion 60 mate with at least a portion of protuberance 17 so that there is provided an overlap of the inner surface of base portion 60 with protuberance 17. Any configuration of the annular sealing ring 66 may be used to provide the facilitation of the corresponding mating surfaces, including, but not limited to, interrupted annular rings, a plurality of protuberances, and combinations thereof. It is also believed that providing a protrusion 69 in the form of an annular ring, plurality of protuberances, and other protuberances known to one of skill in the art, can provide a method of stacking a plurality of overcaps 30b prior to overcap 30b being applied to a container.

As further shown in FIG. 6, it was surprisingly found that a plurality of bumps 68 disposed upon the inner surface of overcap 30b could facilitate the replacement of overcap 30b upon first compartment 11. Without desiring to be bound by theory, it is believed that a plurality of bumps 68 could facilitate replacement of overcap 30b. It is further believed that the plurality of bumps 68 disposed upon the inner surface of overcap 30b can effectively translate the horizontal component of a force applied to overcap 30b during replacement of overcap 30b upon first compartment 11 through the plurality of bumps 68 thereby allowing the plurality of bumps 68 to effectively traverse over the edge of first compartment 11 and ultimately aligning the longitudinal axis of overcap 30b with the longitudinal axis of first compartment 11. It is contemplated that the plurality of bumps 68 could comprise a plurality of spherical, semi-spherical, elliptical, quarter-round, and polygonal projections, indentations, and combinations thereof.

FIG. 8 details a second compartment 80 in one exemplary embodiment. Second compartment 80 comprised of a closed round top 81 with a radius R, an open bottom 85, a second body 86 therebetween, and an engagement skirt 82 attached to the open bottom 85. Engagement skirt 82 can operatively engage to overcap 30 or 30b, for example, engage to the second perimeter of overcap 30 or 30b. Overcap 30 or 30b removably seals the open bottom 85. Closed round top 81, overcap 30 or 30b, and the second body 86 define a displayable space 84 for displaying a second product. The weight of the second compartment 80 is W, the volume of the displayable space 84 is V, and V/W is in the range of 12˜35 mL/gram, preferably in the range of 14˜25 mL/gram, and more preferably in the range of 16˜20 mL/gram (e.g. 17.37 mL/gram).

Specifically, in one embodiment the engagement skirt 82 of second compartment 80 can mate with sealing ring 66 of overcap 30b. After mating, intermediate ring 83 of second compartment 80 can be vertically adjacent with base portion 60 of overcap 30b. Displayable space 84, being bound on the bottom by upper portion 62 of overcap 30b and on the top by closed round top 81 of second compartment 80, defines an actual volume in which an article of commerce can be stored or housed. For example, this displayable space 84 can be the volume in which a sample package of food product, specifically roast and ground coffee, can be housed.

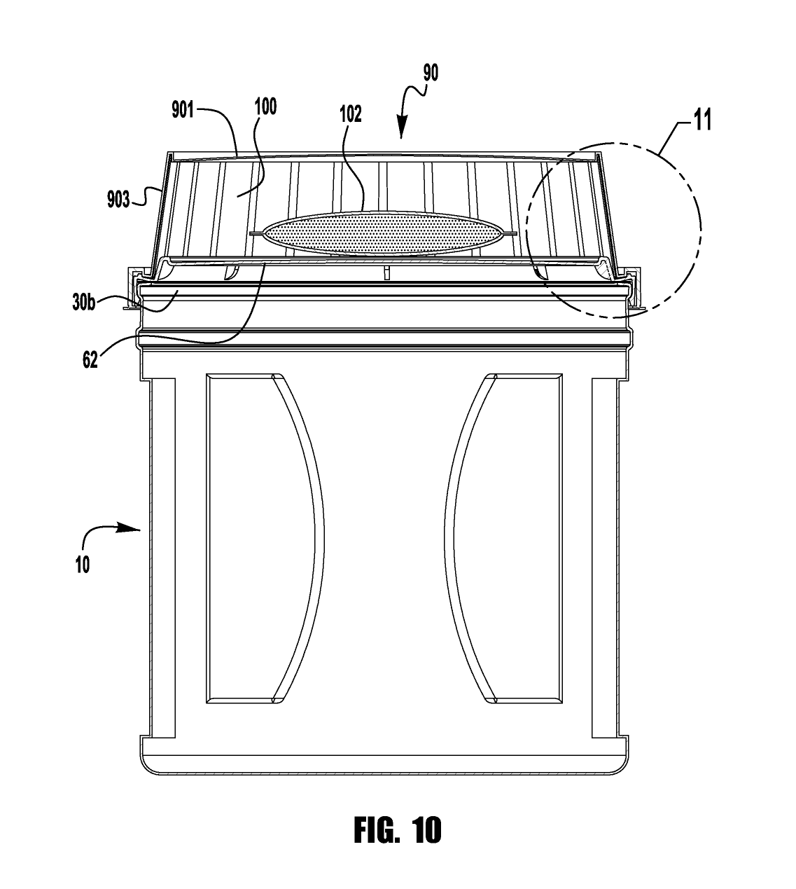

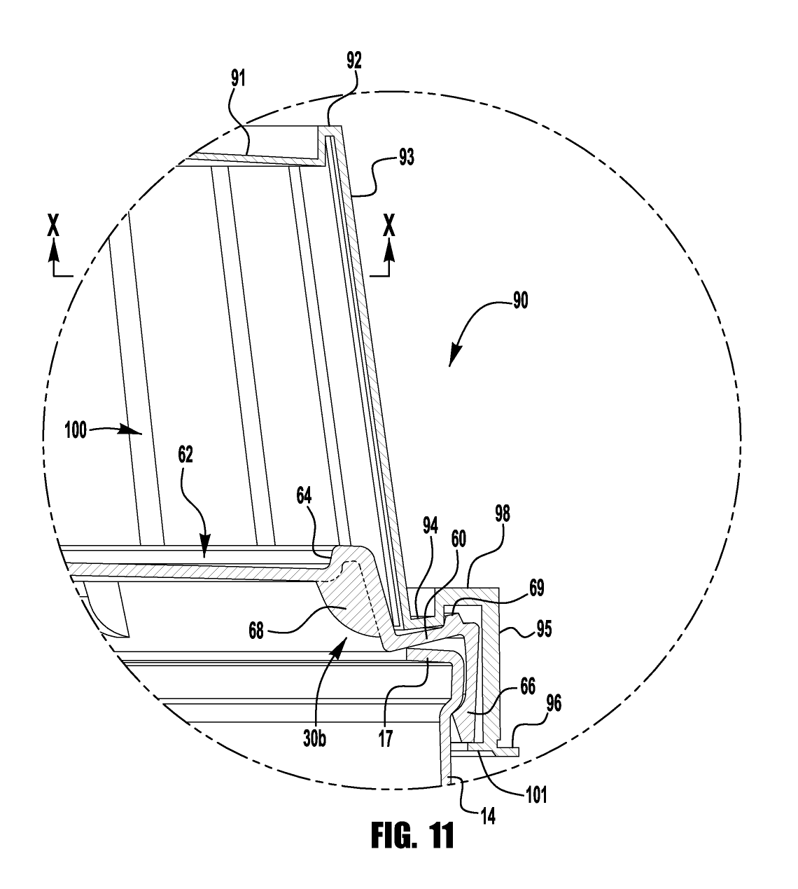

FIG. 9 details another embodiment of a second compartment 90. Second compartment 90 comprises a closed round top 901 with a radius R, an open bottom 902, a second body 903 therebetween, and an engagement skirt 904 attached to the open bottom 902. Closed round top 901 may take the form of a dome with a perimeter, which is surrounded by an elevated ridge. For example, a dome 91 with a circumference defined by annular elevated ridge 92. Elevated ridge 92 extends vertically downwardly to define a first wall 93 of second body 903. Second body 903 may include 1240 vertical grooves (not shown) on wall 93. Elevated ridge 92 can be used as a surface for stacking successive containers. Wall 93 terminates at wall base 94, which circumferentially defines open bottom 902. Wall base 94 is adjacent to engagement skirt 904. A second wall top 98 connects wall base 94 to engagement skirt 904. Engagement skirt 904 extends vertically downwardly and terminates at annular lip 96. A tab 99 can be attached to or formed on lip 96 as a grabbing or pull feature for an end user to remove the second compartment 90 from the first compartment 11 after application. As such, the engagement skirt 904 can be configured to be operatively engaged to the second perimeter of an overcap (not shown). The overcap can removably seal the open bottom 902. The closed top 901, the overcap, and the second body 903 can define a displayable space 97 for displaying a second product. An article of commerce can be placed within space 97 after the second compartment 90 is applied to a container. An example of this configuration is shown in further detail in FIGS. 10 and 11.

FIG. 10 details one embodiment of the second compartment 90 in an applied position. Second compartment 90 has been attached to overcap 30b of container 10. In FIG. 10, displayable space 100 can be formed as the volume between the upper portion 62 of overcap 30b and closed round top 901 of second compartment 90. This displayable space 100 can be used for housing articles of commerce, shown as 102, to be delivered to a consumer, including sample packages of food product, specifically roast and ground coffee, as well as other consumer products, including utensils for use with roast and ground coffee, among other things, all of which will be described in further detail hereinafter. Other articles of commerce can include recipe cards, coupons, pamphlets that can describe health benefits of coffee or other products, giveaways such as, for example, novelty items, and combinations thereof. Further, these articles can be included in combination with sample packages of food products, such as roast and ground coffee. An expanded view of region 11, detailing the fit between the second compartment 90 and overcap 30b, is described below with respect to FIG. 11.

FIG. 11 details one embodiment of the mechanical interaction between overcap 30b and second compartment 90. A manufacturer places second compartment 90 on overcap 30b. The manufacturer then applies pressure on second compartment 90 such that engagement skirt 904 and hump 101 transfer pressure onto the surface area of annular seal ring 66. As shown in FIG. 11, second wall top 98 then can seat on protrusion 69, and wall base 94 situates into the area above base portion 60. Hump 101 can lockingly engage the surface area of annular seal ring 66 and can provide a relatively snug or tight fit. Lip 96 provides an engagement surface for a consumer to remove the second overcap 90. Lip 96 alternatively can include a further prominence portion as a tab 99 (shown in FIG. 9) that further extends from lip 96 and defines a pulling feature for an end user. Any configuration of the engagement skirt (904) with hump 101 may be used to provide the facilitation of the corresponding mating surfaces, including, but not limited to, interrupted annular rings, a plurality of ribs, and combinations thereof.

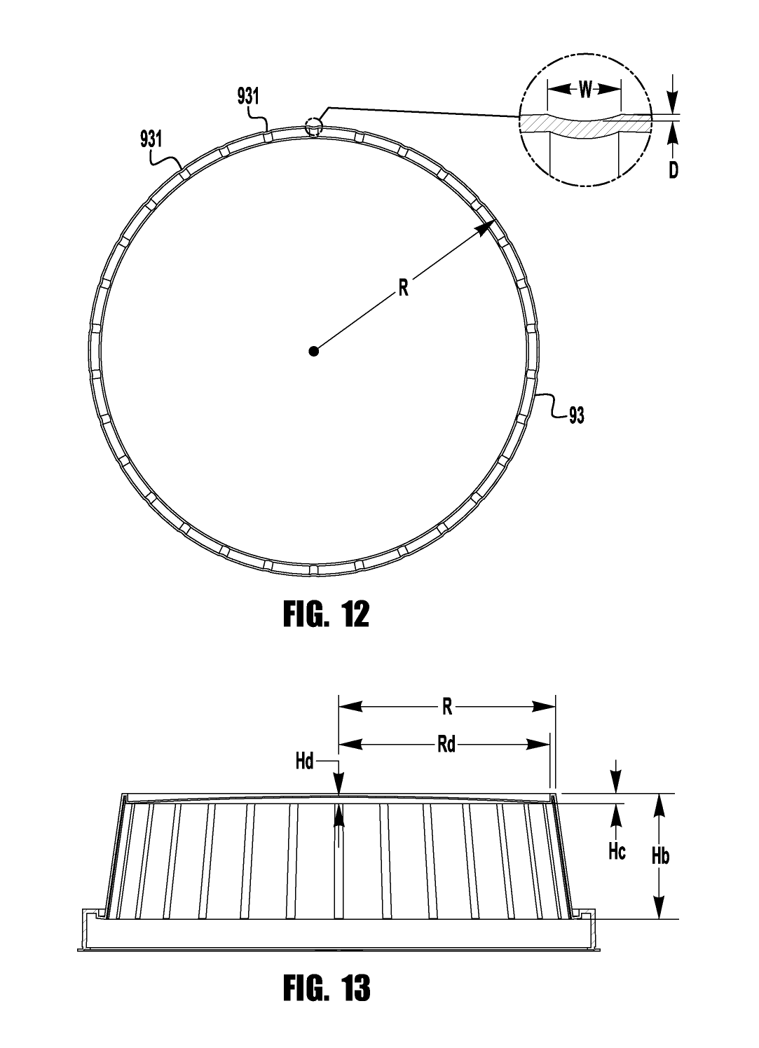

FIG. 12 shows the top cross-sectional view of the second compartment in FIG. 11 cutting along line x-x, with a particular focus on various dimensions, based on that the second compartment has a closed round top with a radius R. Disposed on wall 93 are about 12˜40, preferably 20˜38, and more preferably 25˜35 (e.g. 30), same or different vertical grooves 931. Each of the grooves 931 can have a width W, and W/R is in the range of from 2% to 7%, preferably in the range of from 3% to 6%, and more preferably in the range of from 4% to 5% (e.g. 4.5%). Each of the grooves 931 can have a depth D, and D/W is in the range of from 10% to 24%, preferably in the range of from 11% to 20%, and more preferably in the range of from 12% to 15% (e.g. 12%).

FIG. 13 is a side view of a second compartment in FIG. 11 for the container of FIG. 1, with a particular focus on various dimensions, based on that the second compartment has a closed round top with a radius R. If the height of the elevated ridge is Hc, Hc/R is in the range of 9˜11%, preferably in the range of 9.5˜10.5, and more preferably in the range of 9.7˜10.3 (e.g. 9.8%). If the height of the dome is Hd, Hd/R is in the range of 9˜12%, preferably in the range of 9.5˜11.5%, and more preferably in the range of 10˜11% (e.g. 10.3%). If the height of the second body is Hb, Hb/R is in the range of 45˜95%, preferably in the range of 47˜75%, and more preferably in the range of 50˜60% (e.g. 50.9%). If the radius of the dome is Rd, Rd/R is in the range of 95˜99%, preferably in the range of 95.5˜98%, and more preferably in the range of 96˜97% (e.g. 96.3%).

It is believed that the annular elevated ridge 92 disposed upon the upper portion of the second compartment provides a platform upon which the bottom of an identical but separate container can sit. As such, multiple containers can be stacked on top of one other in a nesting arrangement. For example, the container can withstand a top load pressure P. Given that the second compartment has a closed round top with a radius R, P/πR² is up to 8.9 lbs. per square inch, preferably up to 9.5 lbs. per square inch, and more preferably up to 10 lbs. per square inch, for example, 8.93 lbs. per square inch.

The thickness profile of the second compartment (refer to either 90 shown in FIG. 9 or 80 shown in FIG. 8) can be uniform, but it can also be varied to meet any specific requirement. In an embodiment, the thickness profile of the second compartment is substantially uniform throughout the entire compartment, for example, 0.034 inches.

Second compartment of the container can be manufactured from a plastic with a low flexural modulus, for example, linear low-density polyethylene (LLDPE), low-density polyethylene (LDPE), high-density polyethylene (HDPE), polyethylene (PE), polypropylene (PP), linear low-density polyethylene (LLDPE), polycarbonate, polyethylene terephthalate (PET), polystyrene, polyvinyl chloride (PVC), copolymers thereof, and combinations thereof. These types of plastics allows for a second compartment that has a high degree of flexibility yet can still provide sufficient rigidity to allow stacking of successive containers. By using a second compartment, mechanical application during packaging as well as re-application of second compartment to overcap 30b after opening by the consumer is facilitated.

The container exhibits advantages including a larger volume of displayable space without using more material and without sacrificing strength. The comparison between the container as disclosed in US Patent Application 20090114650 by Houston et al. vs. an exemplary embodiment (Example 1) is tabulated in Table 1 below.

TABLE 1

| | US Patent | | | |
|---|---|---|---|---|
| | Application | | | |
| Specification | 20090114650 | | Example 1 | |
| R | 2.811 | Inches | 2.737 | Inches |
| Displayable Space Volume V | 228 | mL | 455 | mL |
| Second Compartment | 27.75 | grams | 26.2 | grams |
| Material Usage W | | | | |
| V/W | 8.22 | mL/gram | 17.37 | mL/gram |
| Top load pressure P | ~210 | lbs | ~210 | lbs |
| Hb | 0.869 | Inches | 1.394 | Inches |
| Rd | 2.696 | Inches | 2.636 | Inches |
| Hd | 0.384 | Inches | 0.283 | Inches |
| Hc | 0.369 | Inches | 0.268 | Inches |

| | | | |
|---|---|---|---|
| D | N/A | 0.015 | Inches |
| W | N/A | 0.125 | Inches |

| | | |
|---|---|---|
| Number of Grooves | 0 | 30 (uniformly |
| | | distributed) |

As detailed in the accompanying figures and described hereinabove, a displayable space has been described. Specifically, using the displayable space for housing of sample packages of roast and ground coffee has been described. Generally, sample packages, for example promotional bags of roast and ground coffee, can be included inside the displayable space. These promotional bags of roast and ground coffee can include many different types of flavors and blends, and may contain, for example, Folgers brand Classic Roast, Special Roast, Classic Roast Half Caff, Columbian, Breakfast Blend, French Roast, Gourmet Supreme, Simply Smooth, Folgers Flavors (which includes chocolate silk, French vanilla, cinnamon swirl, and hazelnut), decaf, Gourmet Selections (which includes bistro blend, creme brulee), lively Columbian, morning cafe, caramel drizzle, hazelnut creme, chocolate truffle, vanilla biscotti, espresso roast, and combinations thereof. These are meant to be non-limiting examples of different types and flavors of roast and ground coffee, but it is to be understood that any flavor or blend of coffee can be included. In some embodiments, a package of the sample roast and ground coffee can be selected to be of a different flavor or blend than the flavor or blend that is housed inside the container of the packaging system. In these embodiments, the consumer then has purchased two differing roast and ground coffees, one inside the container of one flavor or blend, and a second inside the displayable space in a sample package of another flavor or blend. Thus, a combination of flavors or blends of roast and ground coffees can be provided. Further, the sample package can include writing, labeling, designs, branding materials, and general information related to the flavor or blend of coffee that it contains.

In certain embodiments, liquid coffee sample products (for example Folgers flavor drops and Folgers coffee concentrates) can be included inside the displayable space.

Furthermore, it is contemplated that more than one sample package of roast and ground coffee can be included within the displayable space of the container. Thus, the container can contain a first flavor or blend of roast and ground coffee, a first sample package can include a second flavor or blend of roast and ground coffee, and a second sample package can include a third flavor or blend of roast and ground coffee. Therefore, in these embodiments, at least three flavors or blends of roast and ground coffee can then be provided to a consumer. Further, it is contemplated that any number of sample packages can be included within the displayable space for delivering multiple flavors or blends of roast and ground coffee to a consumer.

Additionally, articles of commerce other than packages of roast and ground coffee can be included within the displayable space. For example, any consumer product or household good, provided it is of appropriate size, can be included within the displayable space. In one embodiment, a utensil can be housed within the displayable space. The utensil can be a measuring scoop for scooping and measuring an amount of roast and ground coffee. Other articles of commerce can be included in the displayable space that relate to roast and ground coffee, including measuring spoons and additives for coffee such as cream, sugar, sugar substitutes, etc.

The second compartment in certain embodiments can come in a variety of colors or can be translucent, transparent, or opaque. In one embodiment, the second compartment can be transparent. A transparent second compartment facilitates the consumer being able to see the sample package and being able to read the print or design of the sample package, which can include writing, labeling, designs, branding materials, and general information related to the roast and ground coffee contained therein, including the flavor or blend. Thus, with a transparent second compartment, the consumer can read the label of the sample package, which can include the specific flavor or blend contained therein, and can choose which container of roast and coffee ground they want to purchase based oil the flavor or blend of the roast and ground coffee inside the sample package. Thus, a consumer can mix and match flavors and blends based on their desired selection.

With respect to manufacturing, first compartment 11, as shown in FIG. 1, can be produced by blow molding a polyolefinic compound. Polyethylene and polypropylene, for example, are relative low cost resins suitable for food contact and provide an excellent water vapor barrier. However, these materials may not be well suited for packaging oxygen-sensitive foods requiring a longer shelf life. As a non-limiting example, ethylene vinyl alcohol (EVOH) can provide a better barrier for obtaining extended shelf life of oxygen-sensitive foods. Thus, it is contemplated that a thin layer of EVOH sandwiched between two or more polyolefinic layers could solve this problem. Therefore, the blow-molding process can be used with multi-layered structures by incorporating additional extruders for each resin used. Additionally, the container can be manufactured using other methods, including injection molding and stretch blow molding.

While particular embodiments of the container have been illustrated and described, it is contemplated that various other changes and modifications can be made without departing from the spirit and scope of the invention.

1. A container comprising:
a first compartment having a closed bottom, an open top, and a first body therebetween, wherein the closed bottom, the open top, and the first body define a first interior volume for containing a first product; and wherein the first body defines a first perimeter about the open top;
an overcap configured to be operatively engaged to the first perimeter, wherein the overcap has a second perimeter; and
a second compartment having a closed round top with a radius R, an open bottom, a second body therebetween, and an engagement skirt attached to the open bottom, wherein the engagement skirt is configured to be operatively engaged to the second perimeter of the overcap; wherein the overcap removably seals the open bottom; and wherein the closed top, the overcap, and the second body define a displayable space for displaying a second product;
wherein the weight of the second compartment is W, the volume of the displayable space is V, and V/W is in the range of 12˜35 mL/gram.

2. The container according to claim 1, which can withstand a top load pressure P, and wherein P/πR² is up to 10 lbs. per square inch.

3. The container according to claim 1, wherein the second body includes 12˜40 vertical grooves.

4. The container according to claim 3, wherein the second body includes 20˜38 vertical grooves.

5. The container according to claim 3, wherein the second body includes 25˜35 vertical grooves.

6. The container according to claim 3, wherein the each of the grooves has a width W, and W/R is in the range of from 2% to 7%.

7. The container according to claim 6, wherein W/R is in the range of from 4% to 5%.

8. The container according to claim 3, wherein each of the grooves has a depth D, and D/W is in the range of from 10% to 24%.

9. The container according to claim 8, wherein D/W is in the range of from 12% to 15%.

10. The container according to claim 1, wherein the closed round top takes the form of a dome having a perimeter, and an elevated ridge surrounding the perimeter.

11. The container according to claim 10, wherein the height of the elevated ridge is Hc, and Hc/R is in the range of 9˜11%.

12. The container according to claim 10, wherein the height of the dome is Hd, and Hd/R is in the range of 9˜12%.

13. The container according to claim 1, wherein the height of the second body is Hb, and Hb/R is in the range of 45˜95%.

14. The container according to claim 10, wherein the radius of the dome is Rd, and Rd/R is in the range of 95˜99%.

15. The container according to claim 1, wherein the second compartment is translucent or transparent.

16. The container according to claim 1, wherein the first product and the second product are the same type of food product.

17. The container according to claim 1, wherein the first product and the second product are different types of food product.

18. The container according to claim 1, wherein the first product is roast and ground coffee.

19. The container according to claim 1, wherein the second product is roast and ground coffee.

20. The container according to claim 1, wherein the second compartment further comprises a third product for displaying.
